(19) United States
(12) Patent Application Publication
(10) Pub. No.: US 2006/0184819 A1
(43) Pub. Date: Aug. 17, 2006

(54) Cluster computer middleware, cluster computer simulator, cluster computer application, and application development supporting method

(76) Inventor: Tarou Takagi, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/331,138

(22) Filed: Jan. 13, 2006

(30) Foreign Application Priority Data
Jan. 19, 2005 (JP) JP 2005-011576
Dec. 15, 2005 (JP) JP 2005-361565

(51) Int. Cl. G06F 11/00

(52) U.S. Cl. 714/4

(57) ABSTRACT

A “session” is used to describe states of cluster computer middleware. The “session” is a sequence of coherent processes and satisfies the following two conditions. (a) A notification is issued to an application each time the session starts or terminates. (b) Two sessions maintain any of anteroposterior relation, inclusion relation, and no relation.

### CLAIM OF PRIORITY

The present application claims priorities from two Japanese applications (1) JP 2005-011576 filed on Jan. 19, 2005, and (2) JP 2005-361565 filed on Dec. 15, 2005, those contents of which are hereby incorporated by reference into those applications.

### BACKGROUND OF THE INVENTION

1. Field of the Invention

The present invention relates to cluster computer middleware and more particularly to cluster computer middleware capable of easily porting and developing applications.

2. Related Background Art

A “cluster computer” is defined as multiple networked computers for cooperation. The cluster computer is a type of parallel computers. Particular attention is paid to the cluster computer as means for implementing ultrahigh-speed computation at relatively low costs against the backdrop of the rapid trend toward high performance and lower prices of personal computers.

An example of the cluster computer is described in Japanese Patent Laid-Open No. 2002-25935. There are many types of cluster computers that are available in different physical configurations and operation modes and are subject to different problems to be solved. The cluster computer in this example connects geographically distant computers with each other using the wide area network operating at a relatively low transmission speed. To improve the performance of the overall system, the above-mentioned publication discloses the technique for distributing loads of the routers distributed in the wide area network. That is, the technique is configured to distribute application jobs based on the resource management information about each cluster apparatus and the network control information. As will be described later, the cluster computer according to the present invention differs from the cluster computer according to the above-mentioned publication in physical configurations and operation modes. Accordingly, the problem to be solved in the present invention differs from the problem according to the above-mentioned publication to improve the performance of the overall system.

An ordinary cluster computer is composed of one computer referred to as a “master computer” and multiple computers referred to as “slave computers.” Normally, applications are running on the master computer. When control reaches a point where a parallel operation is needed, the master computer distributes raw data to respective slave computers. The master computer determines a range of processes assigned to each slave computer and instructs each slave computer to start the process. When completing the process, the slave computer transmits partial result data to the master computer. The master computer integrates the partial result data into one coherent result data. In the following description, the term “procedure” is used to represent a sequence of operations to be performed to implement the parallel operation. An actual application may often use not only the above-mentioned simple procedure, but also more complicated procedures so as to shorten the time needed for processes and decrease the necessary memory capacity.

The cluster computer greatly differs from an ordinary computer in the configurations. An ordinary application cannot be unchangedly run on the cluster computer. To create an application running on the cluster computer, the application needs to be designed to be dedicated to the cluster computer from the beginning. Such application needs to include basic functions such as distributing and collecting data, transmitting an instruction to start processing, and receiving a notification to terminate processing.

These basic functions are collected to constitute software that can be easily used from applications. Such software is referred to as “cluster computer middleware.” The cluster computer middleware is network software situated between an application and the computer. The cluster computer middleware has functions of monitoring or changing connection and operation states of respective computers, distributing instructions from the application to the computers, and collecting notifications from the computers and transferring them to the application. The use of the cluster computer middleware decreases the need for the application to be aware of data communication between the computers. This makes it possible to simplify programming for the cluster computer. An example of this cluster computer middleware is described in Japanese Patent Laid-Open No. 2004-38226.

### SUMMARY OF THE INVENTION

However, in the above conventional art, considerable costs and efforts, and advanced knowledge and technology have been required to develop the parallel applications. Also, it is difficult to give high extensibility and upward compatibility to the parallel applications to be developed.

For example, conventionally, general cluster computer middleware transfers instructions and notifications supplied from the application or computers without any process to destinations. For this reason, a general application had to be designed so that it instructs each computer to start a process and then enters a loop awaiting a notification to terminate the process from the computers. This will be described with reference to the accompanying drawings.

FIG. 23 diagrammatically illustrates information exchange between an application and the cluster computer middleware for implementing the above-mentioned parallel operation on a cluster computer 100. When control reaches a point where a parallel operation is needed, the application normally running in a master module issues instructions 310 (310A, 310B, 310C) for requesting to start a partial process to each slave module. The slave module receives this instruction and performs the corresponding process. When completing the process, the slave module issues a notification 320 about the process completion to the master module. While the slave modules are performing the processes, the master module awaits the notifications 320 (320A, 320B, 320C) from the slave modules.

To clarify the problem of the conventional cluster computer middleware, the following describes an example of a simple application and how to port it to the cluster computer 100. FIG. 24 schematically shows a source code before parallelization. This application sequentially executes ProcessA equivalent to preprocessing, ProcessB equivalent to main process, and ProcessC equivalent to postprocessing. ProcessB is a repetitive process and requires a long time for execution. Accordingly, let us suppose to parallelize ProcessB.

The conventional cluster computer middleware is used to parallelize the application in FIG. 24 to generate a new application's master module. FIG. 25 schematically shows this master module's source code. It can be understood that the source code after the parallelization is very illegible compared to the source code before the parallelization. For example, this source code contains process blocks 430 and 420. The process block 430 is triggered by a specific process in the master module. The process block 420 is triggered by the notification 320 issued from the slave module. The process block 430 needs to use a loop for awaiting the slave module process to terminate. The process blocks 420 and 430 are asynchronously executed by different triggers. Consequently, a variable used by these process blocks needs to be defined as a global variable 410. In modern programming based on object orientation, it is not recommended to use global variables, and therefore, this is undesirable.

While Process A and Process C are placed in the order of execution in FIG. 24, these processes are coded in completely different portions and are placed in reverse order. Although not shown in FIG. 25, it is required to provide a scheme for avoiding the reentrance (restarting the same process before termination of the process) so as to prevent interference between process blocks that are actually executed asynchronously. In consideration for error countermeasures against failures in slave computers 110b through 110i and a communication network 120, it is very difficult to parallelize applications using the conventional cluster computer middleware.

In this manner, the conventional technology is inevitably subject to degraded legibility of applications and difficulty in debugging because computers asynchronously issue notifications. When notifications are “issued asynchronously,” this signifies that a “sub-process” running on the slave computer triggers a notification to be issued irrespectively of a “main process” running on the master computer. As a result, the following problems occur.

(1) When an error occurs, it is difficult to specify whether the error occurs in the main process or the sub-process. Consequently, systematic debugging is hardly available.

(2) The sequence to execute the main process differs from that written in the source code. Accordingly, the source code structures completely differ from each other before and after the parallelization. Further, the main process contains many loop processes awaiting notification, degrading the source code legibility.

(3) The main process depends on the sequence of sub-processes to be executed. When the middleware is modified to change the sequence of executing the sub-processes, the application using them also needs to be recreated.

(4) The main process varies with the parallel operation procedure. When there are many processes to be parallelized such as libraries, respective processes are coded in completely different structures, making the source code management difficult.

(5) Since it is difficult to simulate operation timing of an independently operating slave computer, an actual cluster computer needs to be used to develop an application that ensures reliable operations.

(6) An instruction from the main process immediately forces the sub-process to run. Accordingly, the main process is responsible for managing the timing to execute the sub-process.

The present invention aims at solving the problems of the conventional cluster computer middleware due to asynchronous transmission of a notification from each of computers.

In one aspect, an object of the present invention is to provide a cluster computer middleware that does not require considerable costs and efforts and advanced knowledge and technology in order to develop the parallel applications.

In one aspect, another object of the present invention is to provide a cluster computer middleware that makes it easy to give high extensibility and upward compatibility to the parallel applications to be developed.

Other objects and novel features of the present invention will become apparent from the description of the present specification and attached drawings.

The following briefly summarizes representative aspects of the present invention disclosed in the application concerned.

(1) There is provided cluster computer middleware which operates on a cluster computer composed of a plurality of computers connected to each other via a communication network and provides an application with a function of cooperatively operating the plurality of computers, the cluster computer middleware comprising: a function of receiving an instruction from the application operating on one or more of the plurality of computers; a function of supplying a notification to the application; a function of publishing sessions constituting a specified topological structure representing a process to be performed by the computer; and a function of supplying the application with the single notification indicating initiation of each of the sessions and the single notification indicating termination of each of the sessions.

(2) A cluster computer middleware having a scheduler that temporally blocks the processing of the applications and operates and unit for executing an event handler that is set by the application in advance upon receiving an instruction from the scheduler.

According to one aspect of the present invention, since the notification from the respective computers is not asynchronously transmitted, the readability of the application is improved, and debug becomes easy.

Also, according to another aspect of this invention, the actual configuration of the cluster computer can be concealed from the applications. For that reason, it is unnecessary to implement the procedure depending on the configuration of the cluster computer in the application. Also, it is possible to operate the same application by the cluster computers different in structure from each other.

### BRIEF DESCRIPTION OF THE DRAWINGS

FIG. 1 exemplifies the hardware configuration of a cluster computer 100.

FIG. 2 exemplifies a simple parallel operation procedure.

FIG. 3 shows the configuration of cluster computer middleware 500 as an embodiment of the present invention.

FIG. 4 shows session properties defined by the cluster computer middleware 500 as the embodiment of the present invention.

FIG. 5 diagrammatically illustrates session relations defined by the cluster computer middleware 500 as the embodiment of the present invention.

FIG. 6 shows a topological structure of sessions defined by the cluster computer middleware 500 as the embodiment of the present invention.

FIG. 7 is a diagram showing the contents of processing that is conducted in the respective sessions shown in FIG. 6.

FIG. 8 shows the configuration of application using cluster computer middleware 500 as an embodiment of the present invention.

FIG. 9 shows the contents of information exchange performed by a master module of the cluster computer middleware 500 as the embodiment of the present invention and by a master module of an application 510.

FIG. 10 schematically shows the source code for the master module of the application parallelized by using the cluster computer middleware 500 as the embodiment of the present invention.

FIG. 11 shows a weather chart plotting system 700 according to another embodiment of the present invention.

FIG. 12 shows a three-dimensional image processing system 800 according to still another embodiment of the present invention.

FIG. 13 shows the configuration of a cluster computer simulator 900 according to yet another embodiment of the present invention.

FIG. 14 is a diagram showing an example of a screen of a cluster computer simulator 900 according to the embodiment shown in FIG. 13.

FIG. 15 is a diagram schematically showing the configuration of the interior of a computer 110 according to the embodiment shown in FIG. 3.

FIG. 16 is a diagram showing a logical configuration of the contents of a cluster computer middleware and an application according to the embodiment shown in FIG. 3.

FIG. 17 is a diagram showing an example of a procedure 1400.

FIG. 18 is a diagram showing a data structure of a data arrangement table 1212.

FIG. 19 is a diagram showing a data structure of a node attribute table 1213.

FIG. 20 is a diagram showing an appearance of control movement between the cluster computer middleware 1200 and the application 1300.

FIG. 21 is a diagram showing an appearance of control movement between the cluster computer middleware 1200 and the application 1300 in more detail.

FIG. 22 is a diagram showing a source code of a master module 1300a of the application 1300.

FIG. 23 shows the contents of information exchange performed by a master module of conventional cluster computer middleware and by a master module of an application.

FIG. 24 schematically shows an application's source code.

FIG. 25 schematically shows the source code for the master module of the application parallelized by using the conventional cluster computer middleware.

### DETAILED DESCRIPTION OF PREFERRED EMBODIMENTS

Embodiments of the present invention will be described in further detail.

[General Configuration of a Cluster Computer]

Before proceeding to the description of the cluster computer middleware according to the present invention, the following briefly describes the general configuration of the cluster computer according to the present invention.

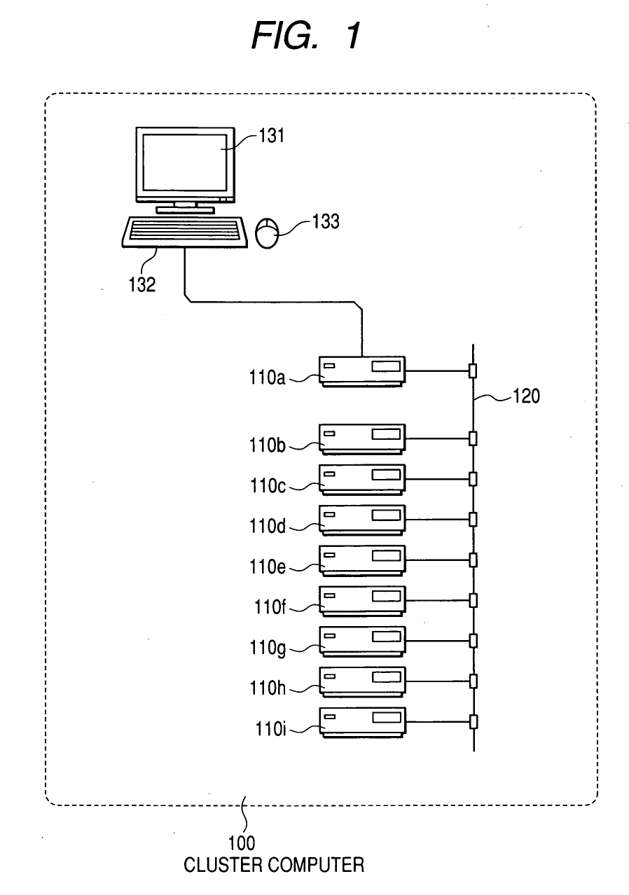

FIG. 1 exemplifies the hardware configuration of a general cluster computer 100. The cluster computer 100 is composed of one master computer 110a and multiple slave computers 110b through 110i. The master and slave computers are connected to each other via a high-speed communication network 120. The master computer 110a has a console composed of a display 131, a keyboard 132, and a mouse 133. By contrast, the slave computers 110b through 110i have no consoles and are indirectly operated from the master computer 110a via the communication network 120.

In the cluster computer 100, it is assumed that plural computers 110 are arranged at locations that physically approach each other. In this case, a network 120 can be configured by using a switching hub and LAN cables. However, the present invention is applicable to a case in which the plural computers 110 are apart from each other, and the network 120 is configured by using the router and the optical fiber.

Each computer 110 is installed with the cluster computer middleware 500 and an application 510 using it. The cluster computer middleware and the application are each divided into a “master module” and a “slave module.” Accordingly, the following four types of programs are running on the cluster computer 100.

(1) Cluster computer middleware (master module) 500M

(2) Cluster computer middleware (slave module) 500S

(3) Application (master module) 510M

(4) Application (slave module) 510S

Generally, the application is provided as an executable program in terms of both the master module and the slave module. On the other hand, the cluster computer middleware is normally provided as a library. Each module is linked to the corresponding application module for operation.

To perform a parallel operation, the application needs to copy or delete data and perform processes according to a specified procedure. Such procedure is referred to as a “parallel operation procedure.”

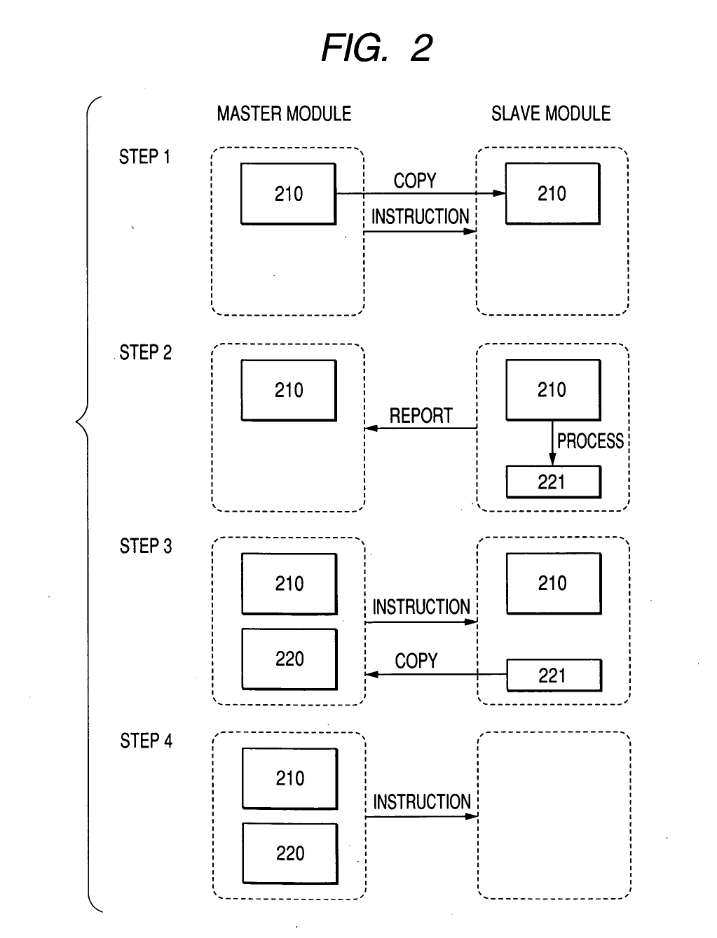

FIG. 2 exemplifies a simple parallel operation procedure. The parallel operation procedure is composed of the following four steps.

Step 1: The master module copies raw data 210 to the slave module and then issues an instruction to start a process.

Step 2: The slave module processes the raw data 210, creates result data 221 as a fragment of result data 220, and reports the master module of process termination.

Step 3: The master module instructs the slave module to copy the result data 221 and integrates the result data transmitted from the slave module to create result data 220.

Step 4: The master module instructs the slave module to delete the raw data 210 and the result data 221. The slave module deletes the raw data 210 and the result data 221.

According to the above-mentioned steps, the result data 220 is created from the raw data 210 similarly to a case where one computer operates.

Hereinafter, a description will be given in more detail of several embodiments of the present invention with reference to the accompanying drawings.

### Embodiment 1

The following describes the cluster computer middleware according to a first embodiment of the present invention.

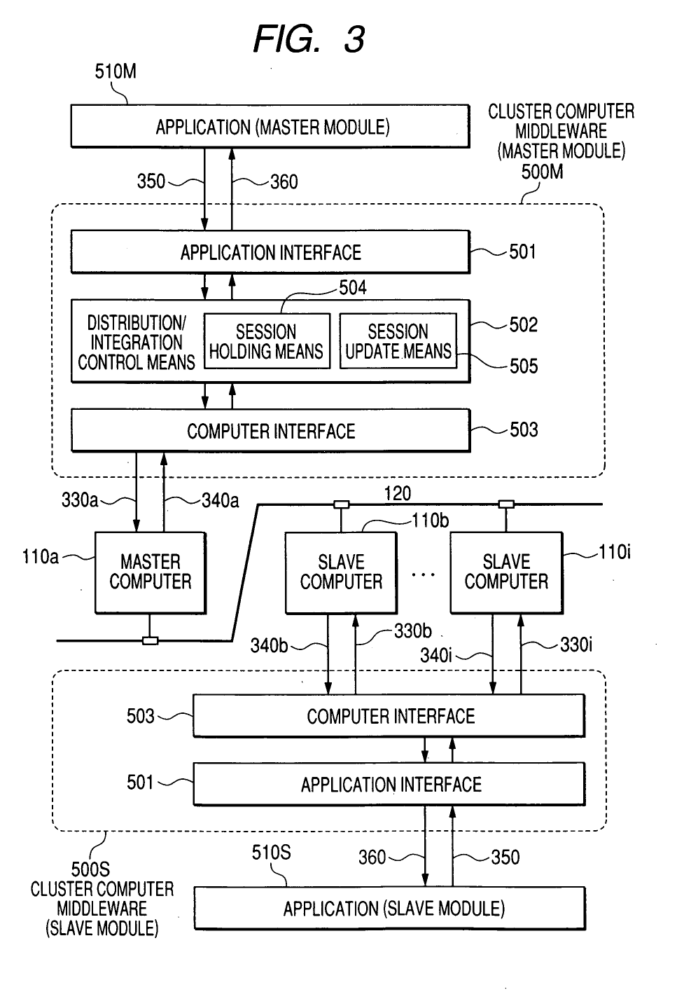

FIG. 3 shows the configuration of cluster computer middleware 500 as the first embodiment of the present invention. The cluster computer middleware 500 is composed of an application interface 501, distribution/integration control means 502, and a computer interface 503. The distribution/integration control means 502 includes session holding means 504 and session update means 505. This characterizes the cluster computer middleware 500 according to the present invention.

The cluster computer middleware 500 is distributed software composed of multiple modules connected by a communication network. The modules are installed on independent computers 110a through 110i. The modules receive an instruction 350 from the application 510 to communicate with each other and force the computers 110a through 110i to operate in cooperation with each other.

The application interface 501 provides a link to the application 510 and is based on library specifications prescribed for each operating system. The application interface 501 publishes, i.e., enables the use of various routines and events in predetermined forms for the application 510.

The distribution/integration control means 502 distributes the instruction 350 received from the application 510 to the computers 110a through 110i, integrates notifications independently supplied from the computers 110a through 110i to create a notification 360, and supplies it to the application 510.

The computer interface 503 supplies an instruction 330 to the computers 110a through 110i connected via the communication network 120 and receives a notification 340 from the computers 110a through 110i. The computers 110a through 110i are each installed with an operating system. The operating system publishes various functions. The computer interface 503 invokes these functions to be able to transmit data to the computers 110a through 110i or start a process.

The session holding means 504 stores and holds which session the cluster computer is currently executing. The concept about the session will be described in detail later.

The session update means 505 is triggered by the instruction 350 from the application 510 or the notification 340 from the computers 110a through 110i to update the session held by the session holding means 504 to a new value.

The following describes the “session” introduced by the cluster computer middleware 500. The “session” is a sequence of coherent processes and satisfies the following two conditions.

a. The notification 360 is issued to the application 510 each time the session starts or terminates.

b. Two sessions maintain any of anteroposterior relation, inclusion relation, and no relation.

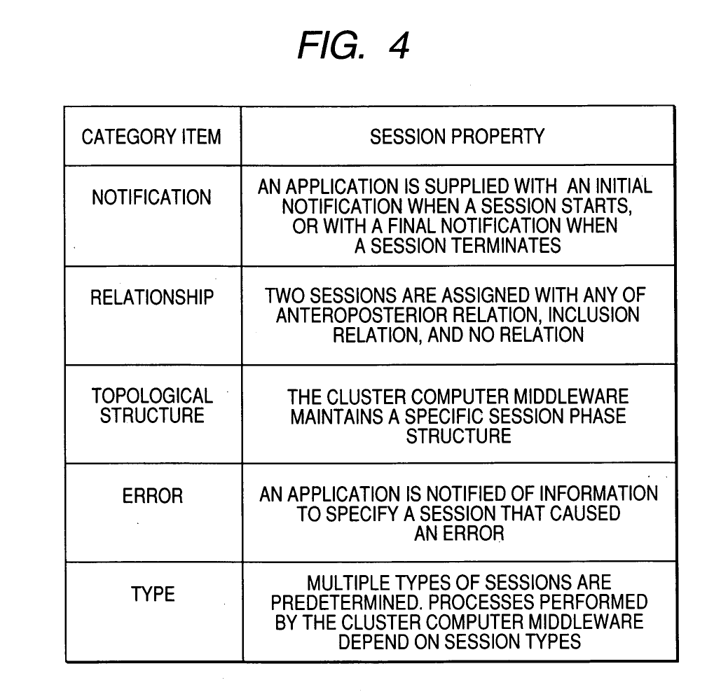

The cluster computer middleware 500 treats the above-defined session as being provided with properties as shown in FIG. 4. The session is the virtual concept introduced by the cluster computer middleware 500 and does not require its entity. When the presence of the session is premised to prescribe specifications of the application interface 501, however, there will be provided a new effect to be described later.

The following describes in detail the above-mentioned two conditions that define the session. First, an initial notification and a final notification will be described. The initial notification corresponds to the notification 360 that is issued immediately after initiation of the session. The final notification corresponds to the notification 360 that is issued immediately before termination of the session. The distribution/integration control means 502 supplies these notifications 360 to the application 510. The final notification is ensured to be issued even when the process causes an error. Using this property, the application 510 can explicitly determine which session is being executed currently.

The initial notification and the final notification are actually provided as “events.” An event belongs to the software scheme to execute a predetermined routine when a specific phenomenon occurs. On the cluster computer middleware 500, initiation and termination of a session are equivalent to phenomena. The event as a routine can take an argument. The application can check or change argument values. Using arguments for the initial event and the final event, the application 510 can check the contents of an operation actually performed by the session or change the contents of an operation to be performed by the session.

Next, the following describes the three relations, i.e., the other condition to validate the session. When session A precedes session B (session B follows session A), this signifies that the final notification for session A is always issued before the initial notification for session B. When session A includes session B (session B is included in session A), this signifies that the initial notification for session A is always issued before the initial notification for session B and that the initial notification for session A is always issued after the initial notification for session B. When no relation is settled between sessions A and B, this signifies that there is not a predetermined sequence of issuing the initial notification and the final notification. The cluster computer middleware 500 defines any of these three relations for any two sessions. To take all prescriptions into consideration, a process to be performed by the cluster computer can be represented as a combination of multiple sessions having a specified topological relation. This is referred to as a “session's topological structure.” The session's topological structure is defined to be specific to each cluster computer middleware 500 and is also published to the application 510. The design of the application 510 needs to examine an algorithm only using the session's topological structure.

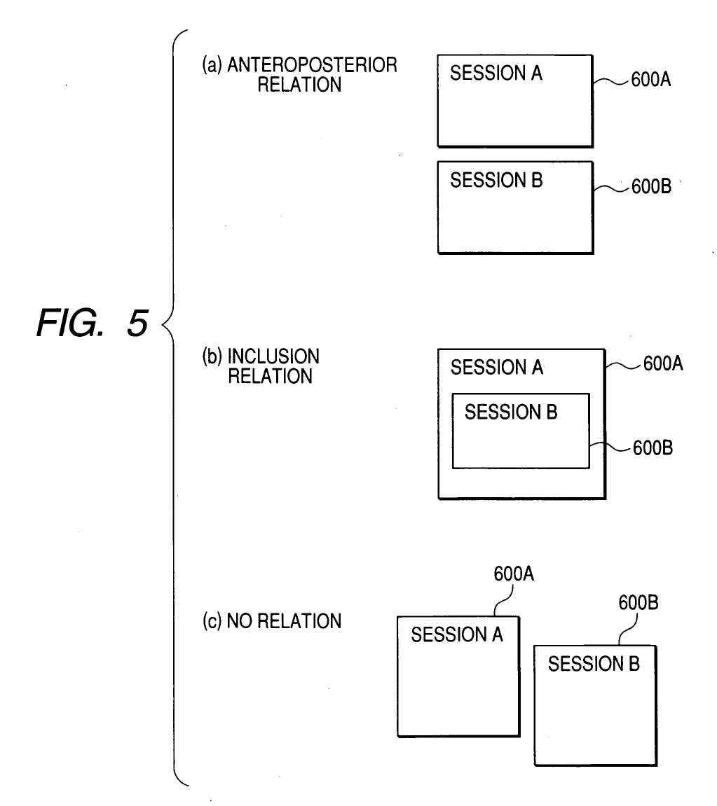

The session relations can be represented by using diagrams as shown in FIG. 5. By this method, a rectangle represents each session 600 and relation between those sessions is described by positional relationship of rectangles. Here, two sessions 600A and 600B are taken up.

According to this method using a figure, as shown in FIG. 5, sessions 600A and 600B having the anteroposterior relation are represented top and bottom as shown in FIG. 5(a). Sessions 600A and 600B having the inclusion relation are nested as shown in FIG. 5(b). Sessions 600A and 600B having no relation are placed horizontally apart from each other and are vertically shifted from each other as shown in FIG. 5(c). When sessions are three or more, it is written by the similar way.

In the representation of sessions 600 using diagrams, it may help the understanding to assume that the ordinate represents a flow of time and the abscissa represents a space (computer 110 or a combination of computers 110) where a process is performed. The session's topological structure is an important property that characterizes the cluster computer middleware 500. When a development support tool adopts the method of representing sessions using diagrams, it is possible to provide an easily understandable user interface that is hardly misunderstood. For such intended purpose, it may be allowed to replace the ordinate with the abscissa and vice versa or place sessions 600 having no relation without vertically shifting them because of restrictions on a screen layout.

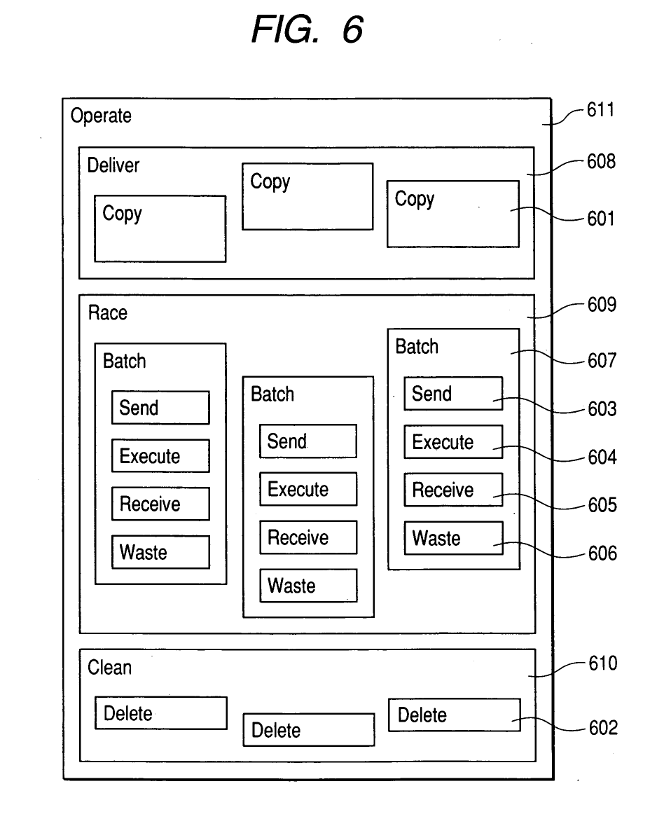

FIG. 6 shows the session's topological structure defined by the cluster computer middleware 500. Each of the sessions 600 performs the following process.

(1) Copy session 601

Copies one piece of data in a node to another node.

(2) Delete session 602

Deletes one piece of data from a node.

(3) Send session 603

Copies data from the master node to a slave node.

(4) Execute session 604

Forces a slave node to execute a task.

(5) Receive session 605

Copies data from a slave node to the master node.

(6) Waste session 606

Deletes data from a slave node.

(7) Batch session 607

Runs distributed processing for one slave node. (8) Deliver session 608

Copies data from the master node to all slave nodes.

(9) Race session 609

Runs distributed processing for all slave nodes.

(10) Clean session 610

Deletes data from all nodes.

(11) Operate session 611

Operates a cluster computer.

In this description, “data” generically denotes data saved as a file on the disk and data stored in a specified memory area. A “node” generically denotes the master computer and the slave computer constituting the cluster computer.

Two types of triggers are used to start and terminate the sessions 600. One is the instruction 350 from the application 510 and the other is the notification 340 from the computers 110a through 110i. Which type of triggers starts or terminates the session 600 depends on which type of sessions is performed or whether or not a session is performed. For example, the instruction 350 triggers the Deliver session 608 to start. The notification 340 triggers the Deliver session 608 to terminate. A trigger to start the Race session depends on whether or not the Deliver session 608 is performed. The notification 340 works as a trigger when the Deliver session is performed. Otherwise, the instruction 350 works as a trigger. The instruction 350 also triggers the Operate session 611 to start. That is, when the application 510 does not issue the instruction 350, no procedure starts.

The initial event and the final event for each session 600 are assigned specific arguments. For example, the initial event for the Copy session 601 is supplied with an index of data to be copied as an argument. The application 510 can suspend the copy by rewriting the argument to 0 (indicating that there is no data). The final event for the Copy session 601 is supplied with an index of the actually copied data as an argument. The value set 0 indicates that an error occurred and no data is copied actually. In this manner, the application 510 can confirm that the session 600 processed appropriately. The Send, Execute, Receive, Waste, Deliver, and Clean sessions (603, 604, 605, 606, 608, 610) can handle multiple pieces of data. These sessions are supplied with a list capable of storing multiple indexes instead of data indexes. The application can add a data index to this list to copy multiple pieces of data to all slave nodes at a time or delete data from multiple nodes at a time.

In consideration for the above-mentioned session 600 properties, it becomes easy to understand operations (the description thereof omitted so far) of the session holding means 504 and the session update means 505. The operations will be described below.

The session holding means 504 stores and holds which session the cluster computer is executing currently. Sessions 600 maintain the hierarchical inclusion relation. The session holding means 504 uses a tree-structured variable to store the currently executed session hierarchy. In an initial state of the cluster computer middleware 500, no session hierarchy is stored in this variable, indicating that no session 600 is running.

The session update means 505 is triggered by the instruction 350 from the application 510 or the notification 340 from the computers 110a through 110i to update the session 600 held by the session holding means 504 to a new value. How the session 600 is updated depends on the current session and the instruction 350 or the notification 340 as a trigger.

Let us suppose that the Deliver session 608 is currently executed and contains several Copy sessions 601. When the computer 120 issues the notification “data copy terminated”, the session update means 505 terminates the Copy session corresponding to this computer 120 and deletes the Copy session from the session holding means 504. When this operation terminates all Copy sessions 601, the session update means 505 terminates the Deliver session 608 and deletes it from the session holding means 504. The session update means 505 starts the succeeding Race session 609 and adds it to the session holding means 504. As mentioned above, the initial notification or the final notification is issued to the application when the session starts or terminates. Depending on needs, it may be preferable to serialize the notifications 360 (not to issue the next notification 360 while the application 510 is executing a process corresponding to one notification 360).

In this manner, based on the concept of the session newly introduced in the present invention, the cluster computer middleware 500 issues the notification 360 to the application 510 according to the instruction 350 from the application 510 or the notification 340 from the computer 110 as a trigger. The programming of the application 510 is to describe processes for these notifications 360.

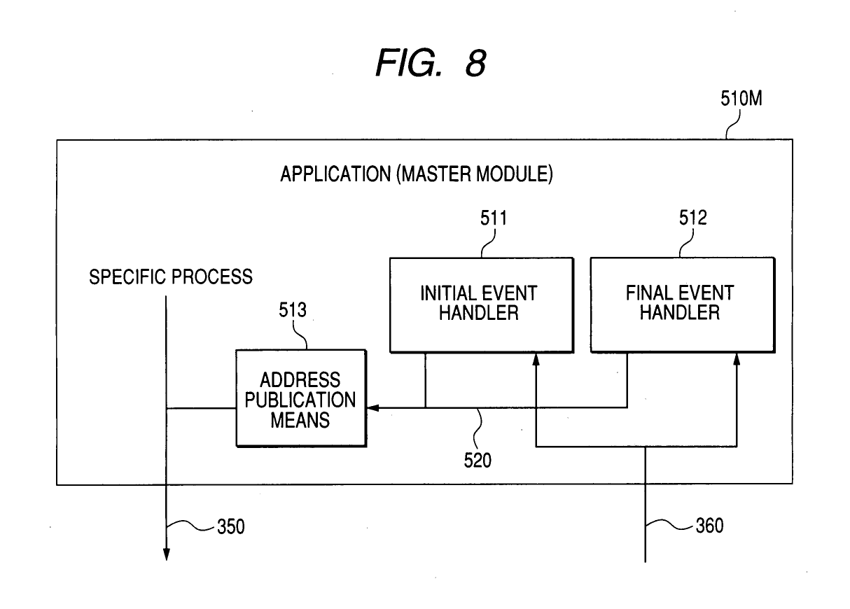

FIG. 8 shows the configuration of the application 510. The application 510 includes an initial event handler 511, an initial event handler 512, and address publication means 513.

The “event handler” is a routine that operates on an event and performs a predetermined process. Since the event handler is actually a function or a procedure, the event handler can be invoked when its form and address are identified. In consideration for this, the application 510 publishes an event handler's address to the cluster computer middleware 500 before the cluster computer middleware 500 starts executing the Operate session 611. The address publication means 513 obtains the event handler's address 520 and adds it as an argument to the instruction 350 that is actually implemented as a mapping function or a procedure. Since the event handler format is predetermined, the cluster computer middleware 500 can execute the initial event handler 511 and the final event handler 512 in accordance with initiation or termination of the session.

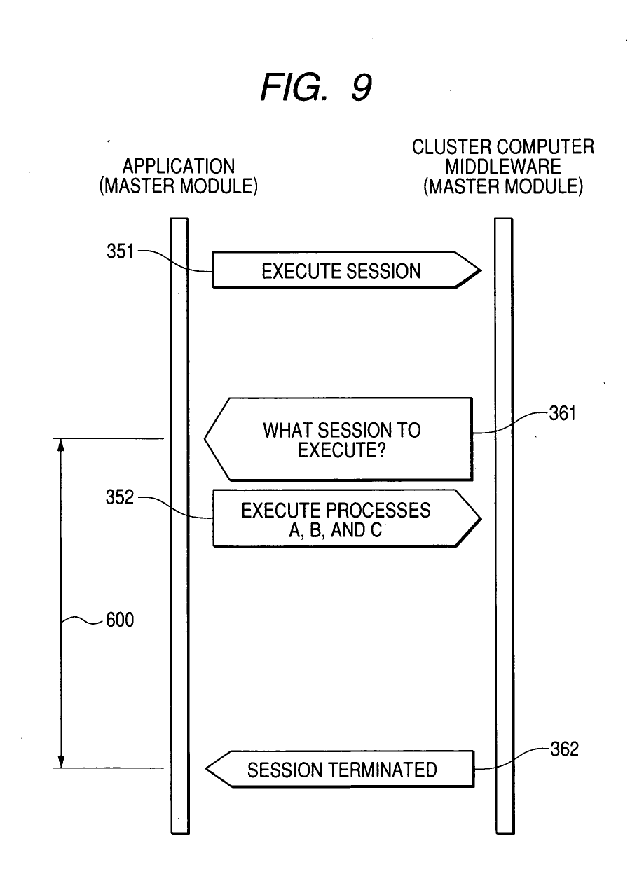

FIG. 9 shows the contents of information exchange performed by the application 510 and the cluster computer middleware 500 on the cluster computer according to the present invention. A session initial notification 361 is sent out in response to a session initial instruction 351, and execution of process A, and are directed as a response to this session initial notification 361.

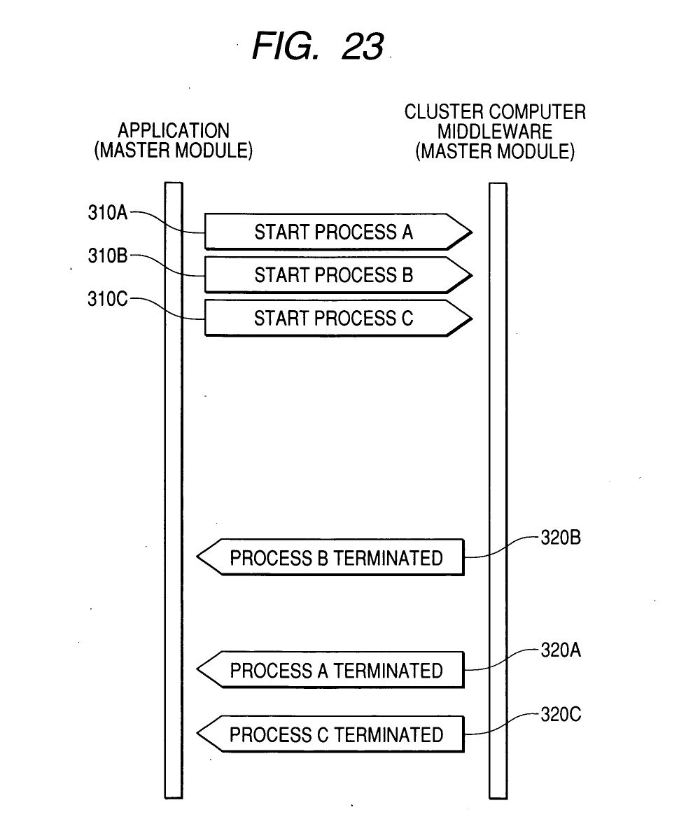

When comparing the contents shown in FIGS.9 and 23, it can be understood that the cluster computer middleware 500 hides the sequence of processes executed by the slave module from the application 510. The application 510 cannot change or check the sequence of processes executed by the slave module and has no necessity to this. The session initial notification 361 executes the initial event handler 511 and automatically issues a session process content instruction 352. The application 510 issues the session initial instruction 351 and then just needs to await termination of a session 600, i.e., a session final notification 362 to be issued. This operation of the application 510 is essentially unchanged even though the session's topological structure is complicated.

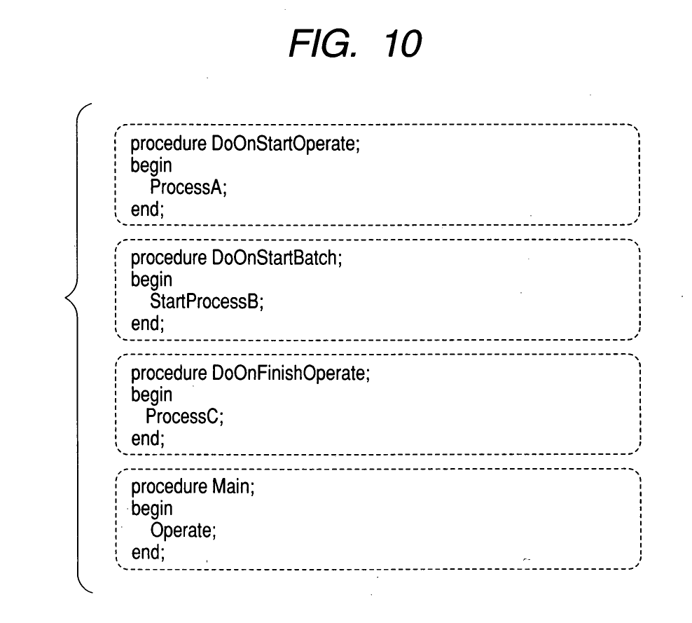

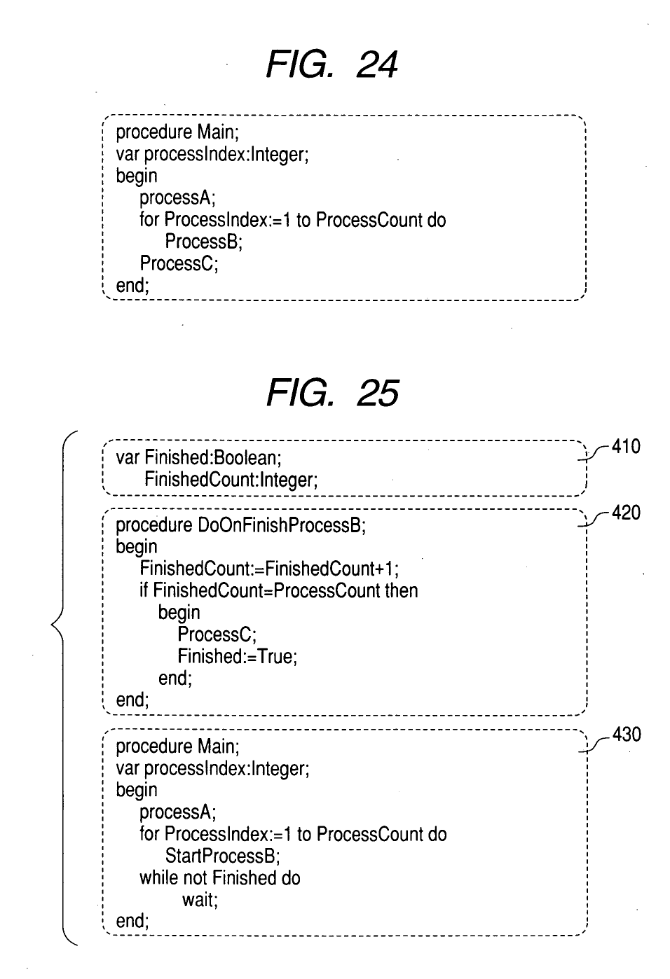

FIG. 10 schematically shows the source code for the master module of the application parallelized by using the cluster computer middleware 500 according to the present invention. When comparing the source codes in FIGS. 10 and 25, it can be understood that the present invention solves many problems in the conventional cluster computer middleware as mentioned above. The new source code is greatly simplified and is easy to be compared with the source code as shown in FIG. 24 before parallelization.

In this manner, the use of the cluster computer middleware 500 provides the following new effects.

(1) When an error occurs, the application 510 can be notified of the current session 600 maintained in the session holding means 504. Accordingly, the application 510 can easily estimate an error occurring location and assist in systematic debugging.

(2) Many notifications 340 are asynchronously generated from the multiple computers 110a through 110i and are integrated to be transmitted to the application 510. Accordingly, the application 510 just needs to code a process to be performed for each session 600 in the order of sessions 600 to be executed. There is no need to code a loop awaiting the notification 360, improving legibility of the source code.

(3) The middleware can be modified by reviewing the order of executing parallel operations without changing the anteroposterior relation and the inclusion relation of sessions 600. The application 510 is designed by only using the anteroposterior relation and the inclusion relation of sessions. The application 510 is ensured to correctly operate even when the middleware is modified.

(4) Even when the procedure of parallel operations is greatly changed, the application 510 just needs to rewrite processes for the initial notification and the final notification. Even when there are many processes to be parallelized, each process can be coded in a similar structure, making the source code management very easy.

(5) There is no need to consider operation timings of individual computers. It is possible to create a simulator having the same session specification as that of the middleware. The use of the simulator can develop an application for parallel operations without using the cluster computer.

(6) An instruction from the main process does not necessarily start a sub-process at once. Accordingly, the main process can be freed from responsibility to manage the timing to execute the sub-process. When the middleware is responsible for sub-process management, the application can be very simple.

### Embodiment 2

The following describes two embodiments, that is, the following description covers a system using the cluster computer middleware 500 and a method of creating the application 510. In the description, as examples, a weather chart plotting system 700 is represented in embodiment 2, and a three-dimensional image processing system 800 is represented in embodiment 3.

In the first, the embodiment of the weather chart plotting system 700 is represented.

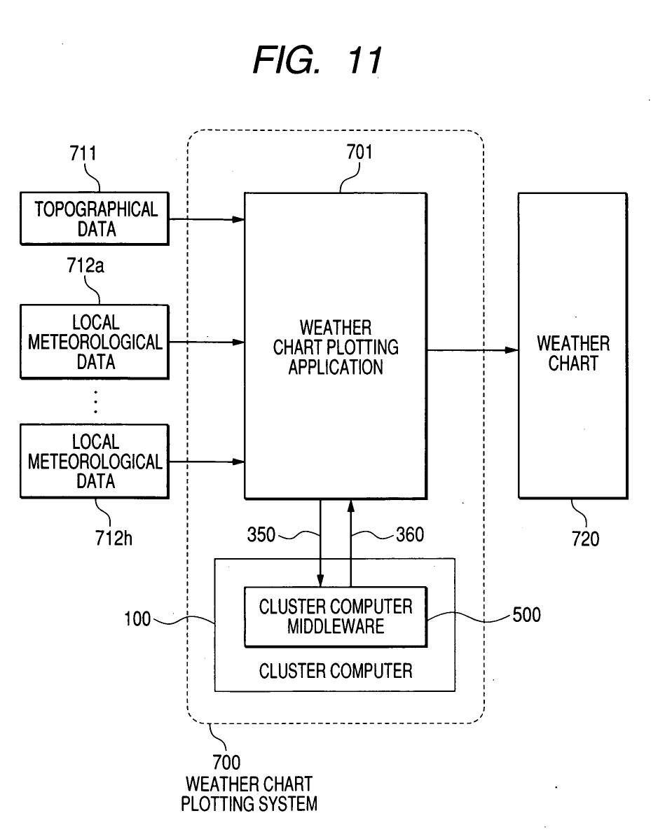

FIG. 11 shows the configuration of the weather chart plotting system 700 using the cluster computer middleware 500 according to the present invention. The weather chart plotting system 700 is composed of a weather chart plotting application 701 and the cluster computer 100. The weather chart plotting system 700 has a function to create a nationwide weather chart 720 based on topographical data 711 and local meteorological data 712a through 712h. The cluster computer 100 is configured by using the cluster computer middleware 500 according to the present invention.

To shorten the time needed for processing, the weather chart plotting system 700 creates weather charts 720 for respective districts and then connects them to create the weather chart 720 for the whole country. Creation of the weather chart 720 for each district needs topographical data 711 and local meteorological data 712 corresponding to the district. That is, the master node must distribute these pieces of data to slave nodes constituting the cluster computer 702.

Of the topographical data 711 and the local meteorological data 712a through 712g, the topographical data 711 does not vary with the time. Accordingly, it is a good practice to distribute the topographical data 711 to each slave node. By contrast, since the local meteorological data 712a through 712g vary with the time, the most recent data needs to be distributed for each process. Since the adopted procedure keeps part of raw data undeleted, it is possible to omit the time needed to distribute the raw data to slave nodes.

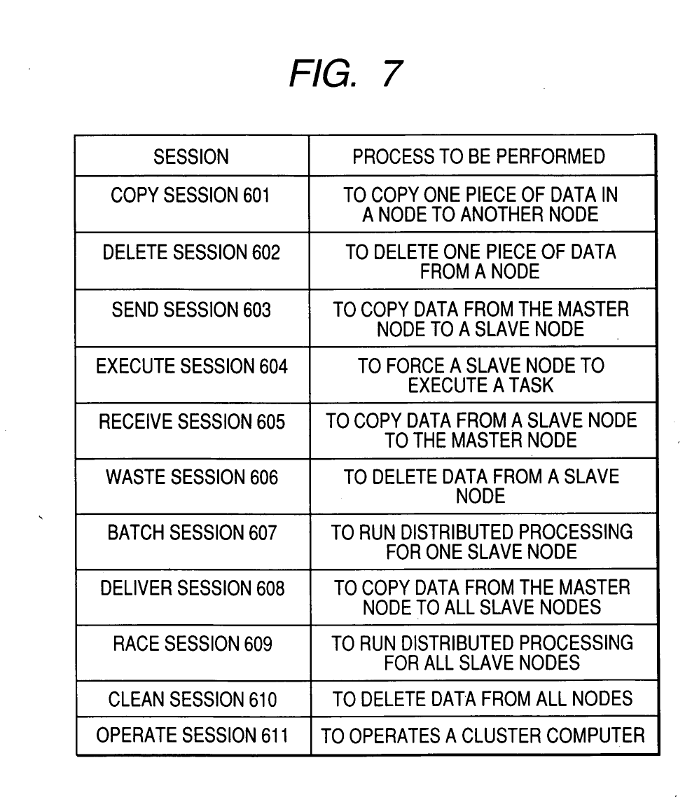

To implement the above-mentioned procedure, the application just needs to operate as follows in accordance with the initial or final event for the sessions as shown in FIGS. 6 and 7.

(1) Initial Event for the Deliver Session

The application checks whether or not the topographical data 711 is distributed the slave nodes. When the topographical data 711 is not distributed, the application issues an instruction to copy the topographical data 711 to each slave node.

(2) Initial Event for the Batch Session

The application issues an instruction to copy the local meteorological data 712a through 712g to the slave nodes.

(3) Initial Event for the Receive Session

The application issues an instruction to copy the local weather chart 720 to the master node.

(4) Final Event for the Receive Session

The application creates the nationwide weather chart 720 from the local weather chart 720 copied to the master node.

(5) Initial Event for the Waste Session

The application issues an instruction to delete the local meteorological data 712 and the local weather chart 720.

As mentioned above, the use of the cluster computer middleware 500 can easily implement the above-mentioned parallel operation procedure just by describing processes for the five events.

### Embodiment 3

The following describes an example of applying the present invention to a three-dimensional image processing system.

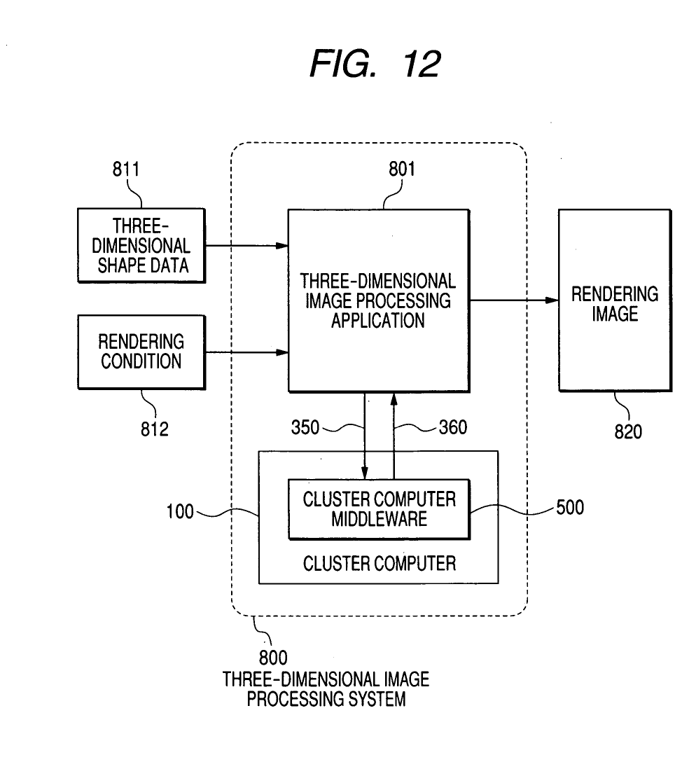

FIG. 12 shows the configuration of a three-dimensional image processing system 800 using the cluster computer middleware 500. The three-dimensional image processing system 800 is composed of a three-dimensional image processing application 801 and the cluster computer 100. The three-dimensional image processing system 800 has a function to create a rendering image 820 for display by applying a rendering condition 812 to three-dimensional shape data 811. The cluster computer 100 is configured by using the cluster computer middleware 500 according to the present invention.

To shorten the time needed for processing, three-dimensional image processing system 800 divides a display area for rendering. This process requires the three-dimensional shape data 811 and the rendering condition 812. The master node distributes the three-dimensional shape data 811 to slave nodes constituting a cluster computer 802 and then transmits the rendering condition 812. Further, the master node specifies different display areas for the slave nodes to perform processes. To uniform loads on all the slave nodes, it is desirable to divide the display area into sufficiently fine portions against the number of slave nodes. When a process terminates on the slave node, the master node must operate so that the next display area is specified for the slave node to perform the next process.

To implement the above-mentioned procedure, the application just needs to operate as follows in accordance with the initial or final event for the sessions 600 as shown in FIGS. 6 and 7.

(1) Initial Event for the Deliver Session

The application issues an instruction to copy the three-dimensional shape data 811 to all slave nodes.

(2) Initial Event for the Execute Session

The application issues an instruction to find a display area corresponding to the number of the Batch session and transmit it together with the rendering condition 812 to the slave node.

(3) Initial Event for the Receive Session

The application issues an instruction to copy the divided rendering image 820 to the master node.

(4) Final Event for the Receive Session

The application uses the divided rendering images 320 copied to the master node and synthesizes them into one coherent rendering image 820.

(5) Initial Event for the Waste Session

The application issues an instruction to delete the divided rendering image 820.

(6) Initial Event for the Clean Session

The application issues an instruction to delete the three-dimensional shape data 811 copied to all the slave nodes.

As mentioned above, the use of the cluster computer middleware 500 can easily implement the above-mentioned parallel operation procedure just by describing processes for the six events.

The weather chart plotting system 700 and the three-dimensional image processing system 800 use the different parallel operation procedures. In any of these systems, the application 510 is nonetheless coded as a set of processes with reference to the initial and final events for the sessions. In this manner, the way of describing source codes becomes independent of parallel operation procedures. This is also an advantage of using the cluster computer middleware 500.

### Embodiment 4

The following describes a cluster computer simulator to which the present invention is applied.

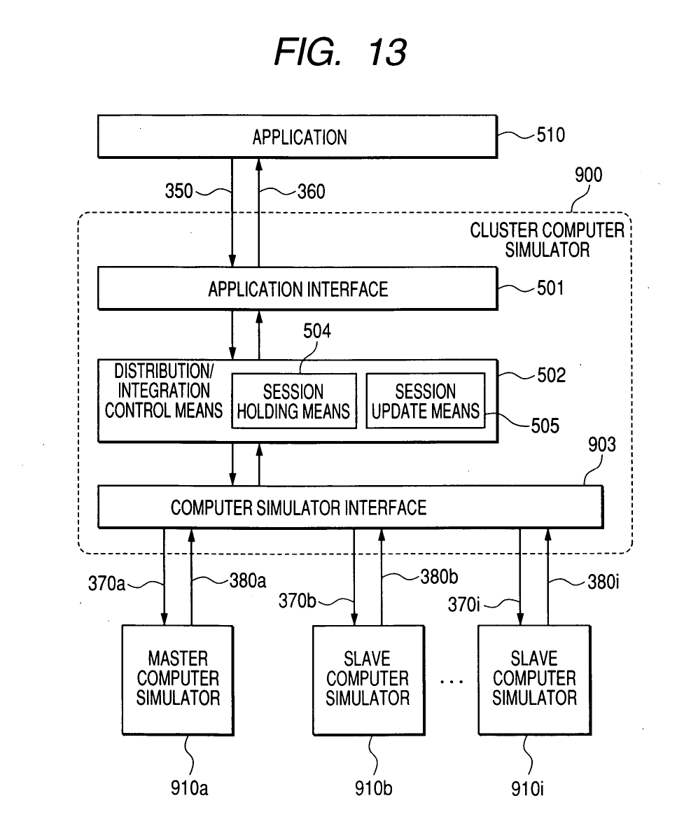

FIG. 13 shows the configuration of a cluster computer simulator 900 according to the present invention. Many components constituting the cluster computer simulator 900 according to the present invention are common to those constituting the cluster computer middleware 500. However, there are several differences between the cluster computer simulator 900 and the cluster computer middleware 500. The cluster computer simulator 900 running on one computer uses computer simulators 910a and 910b through 910i instead of the actual computer 110. The cluster computer simulator 900 is devoid of components concerning the slave computer and the slave module. The cluster computer simulator 900 uses a computer simulator interface 903 instead of the computer interface 503. The cluster computer simulator 900 uses a simulated instruction 370 and a simulated notification 380 independently of the communication instead of the instruction 330 and the notification 340 transmitted via the communication network 120. On the other hand, the session's topological structure and the same application interface 510 are common to the cluster computer simulator 900 and the cluster computer middleware 500. When the application 510 correctly operates in link with the cluster computer simulator 900, the application 510 is ensured to also correctly operate in link with the cluster computer middleware 500.

The computer simulator 910 simulates operations of the respective computers 110. To correctly simulate operations of the independently operating multiple computers 110, the computer simulator 910 is installed as an independent thread (a unit of process capable of being executed simultaneously in a program).

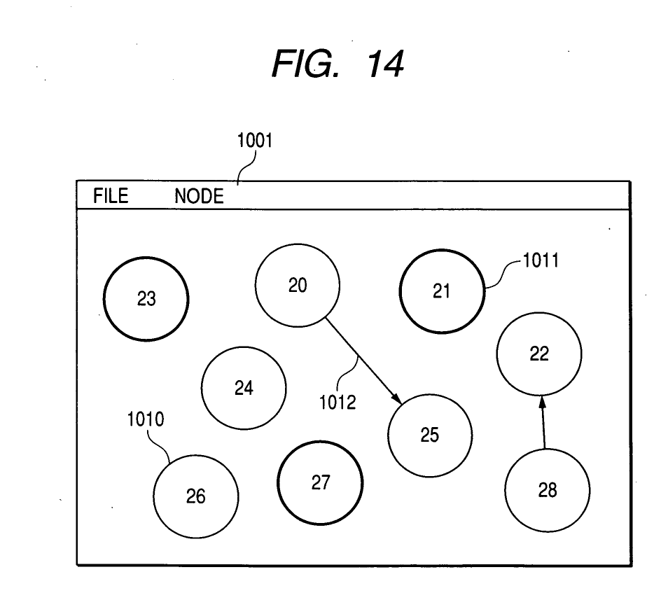

FIG. 14 shows a screen example of the cluster computer simulator 900. The screen shows multiple circles marked with IP addresses. Each circle corresponds to the computer simulator 910. Operating a command menu 1001 can add or delete a circle or change an IP address. It is possible to create the same configuration as the actually used cluster computer.

While the cluster computer simulator 900 is operating, the screen changes realtime according to the state of each computer simulator 910. A thin circle 1010 represents the inactive computer simulator 910. A thick circle 1011 represents the active computer simulator 910. An arrow 1012 represents data copy.

Mouse-clicking on the circle can display data (file or memory) maintained in the computer simulator 910. Using this function, it is possible to confirm whether or not necessary data is delivered before the slave computer starts a process. Further, it is possible to confirm whether or not unnecessary data remains when a sequence of processes terminates. The function is helpful to the development of the highly reliable application 510.

### Embodiment 5

A description will be given of a cluster computer middleware according to a fifth embodiment of the present invention.

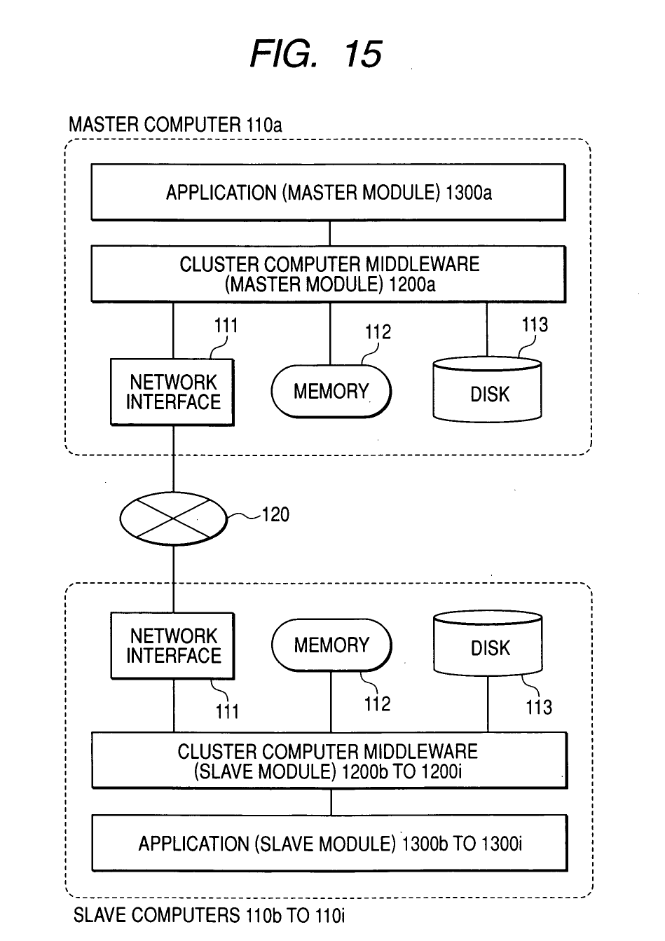

First, FIG. 15 schematically shows the configuration of the interiors of a master computer 110a and slave computers 110b to 110i which configure the cluster computer 100 according to a fifth embodiment. In each of the master computer 110a and the slave computers 110b to 110i, the cluster computer middleware 1200 and the application 1300 are divided into master modules and slave modules, respectively, and installed. Each of those computers 110 includes a network interface 111, a memory 112, and a disk 113. The cluster computer middleware 1200 and the application 1300 are stored in the disk 113. The cluster computer middleware 1200 and the application 1300 are loaded in the memory 112, and operate while linking with each other. The network interface 111 connects the master computer 110a and the slave computers 110b to 110i to each other on the network. For that reason, data communication can be conducted between arbitrary computers 110. In the following description, the expressions of “master” and “slave” are appropriately omitted so far as it appears that no misunderstanding occurs.

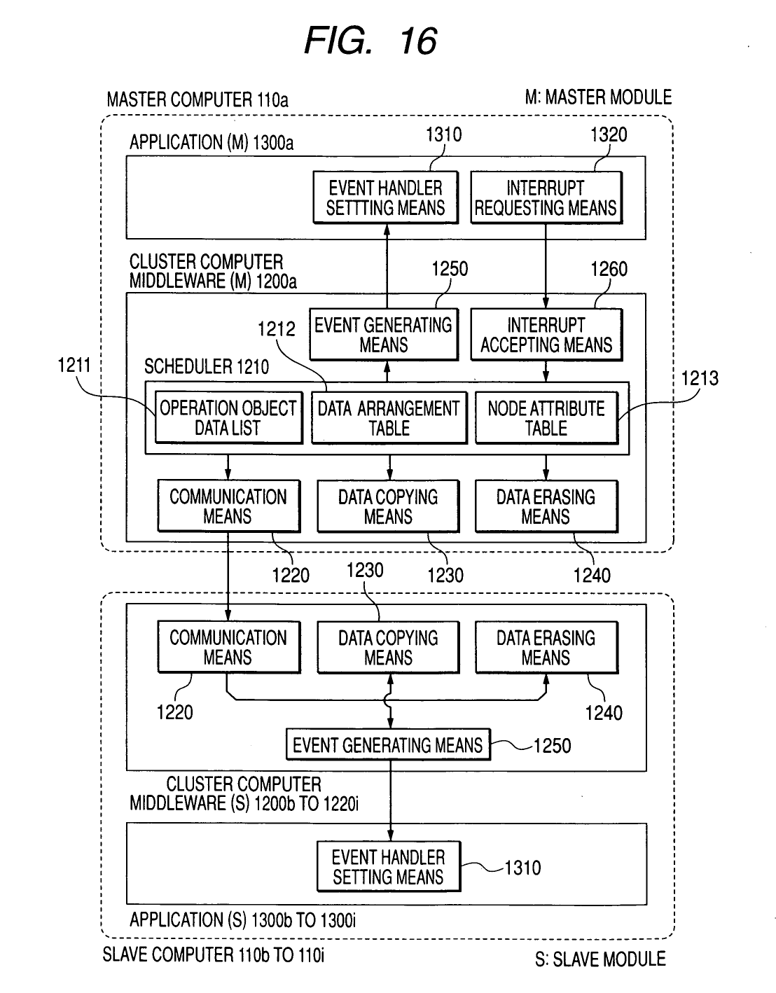

FIG. 16 shows the logical configuration of the interiors of the cluster computer middleware 1200 and the application 1300. The master module 1200a and the slave modules 1200b to 1200i of the cluster computer middleware 1200 commonly include communication means 1220, data coping means 1230, data erasing means 1240, and event generating means 1250. Also, only the master module 1200a has a scheduler 1210 and an interrupt accepting means 1260.

The scheduler 1210 has a function of transmitting instructions to the data copying means 1230, the data erasing means 1240, and the event generating means 1250 according to a predetermined procedure. As a result, in fact, data copying, data erasing, and event generation are conducted.

The communication means 1220 transmits the instructions transmitted from the scheduler 1210, and a memory block and file data which are stored in the memory 112 and the disk 113 to another computer. This is usually installed by the scheme of socket communication that is supplied by the operation system (OS).

The data copying means 1230 has a function of receiving the instruction that is transmitted from the scheduler 1210 and copying the memory block or the file data. In the case where data is copied by another computer, the data copying means 1230 indirectly uses the communication means 1220 and transmits data. This is usually installed by the scheme of the disk operation or the memory operation which is supplied by OS.

The data erasing means 1240 has a function of receiving the instruction that is transmitted from the scheduler 1210 and erasing the memory block or the file data. This is usually installed by the scheme of the disk operation or the memory operation which is supplied by OS.

The event generating means 1250 has a function of receiving the instruction that is transmitted from the scheduler 1210 and executing a routine that is set by the application 1300 in advance. This routine is called “event handler”. This is usually installed by the scheme of a routine callback (the function of the application is used from a library) which is supplied by OS. In the event handler, arbitrary processing including data production and conversion can be conducted. Also, it is possible to give an operation object data list 1212 provided in the scheduler 1210 to the argument of the event handler. The operation object data list 1212 is data that is copied or erased by the cluster computer middleware 1200, or data list that has been copied or erased by the cluster computer middleware 1200. The application 1300 is capable of adding or deleting an index (memory block address, file name, etc.) for identifying data with respect to the operation object data list 1212. In the cluster computer middleware 1200, in fact, a timing at which data copying or erasing is conducted cannot be controlled by the application 1300. In other words, in order to control and monitor data copying and erasing in the application 1300, there must be used a method in which data to be operated is set in advance or data to be operated is acquired ex post facto by using the operation object data list 1212 in the event handler.

The timing which event generates is left to the scheduler 1210. However, in order to arrange systematically the order which various kinds of events generate and make it easy to understand, it may specify as an event occurs at the beginning and the end by introducing the view of session 600 indicated in the embodiment 1.

The interrupt accepting means 1260 has a function of receiving an asynchronous processing request such as an acquisition of a process completion ratio or an interrupt of processing, and notifying the scheduler 1210 of the request.

The master module 1300a and the slave modules 1300b to 1300i of the application 1300 commonly include event handler setting means 1310. Also, the master module 1300a of the application 1300 has interrupt request means 1320.

The event handler setting means 1310 has a function of setting the event handler which is executed by the operation of the event generating means 1250. This is usually installed by the scheme of the routine callback that is supplied by OS.

The interrupt requesting means 1320 has a function of requesting asynchronous processing such as an acquisition of a process completion ratio or an interrupt of processing of the scheduler 1210. This is usually installed by the scheme of a routine export (the function of a library is used from the application) which is supplied by OS. The acquisition of the processing completion ratio is usually conducted by a timer that is supplied by OS. Also, the interrupt of the process is usually conducted by the operation of the user.

With the above configuration, in the cluster computer 100, the scheduler 1210 can intensively control data copying, data erasing, and event occurrence in the respective computers 110. Those three operations become elements that realize various parallel processes. The various parallel processes can be realized by the combination of those elemental operations. In other words, whether the cluster computer 100 normally operates or not depends on whether the scheduler 1210 normally conducts scheduling, or not.

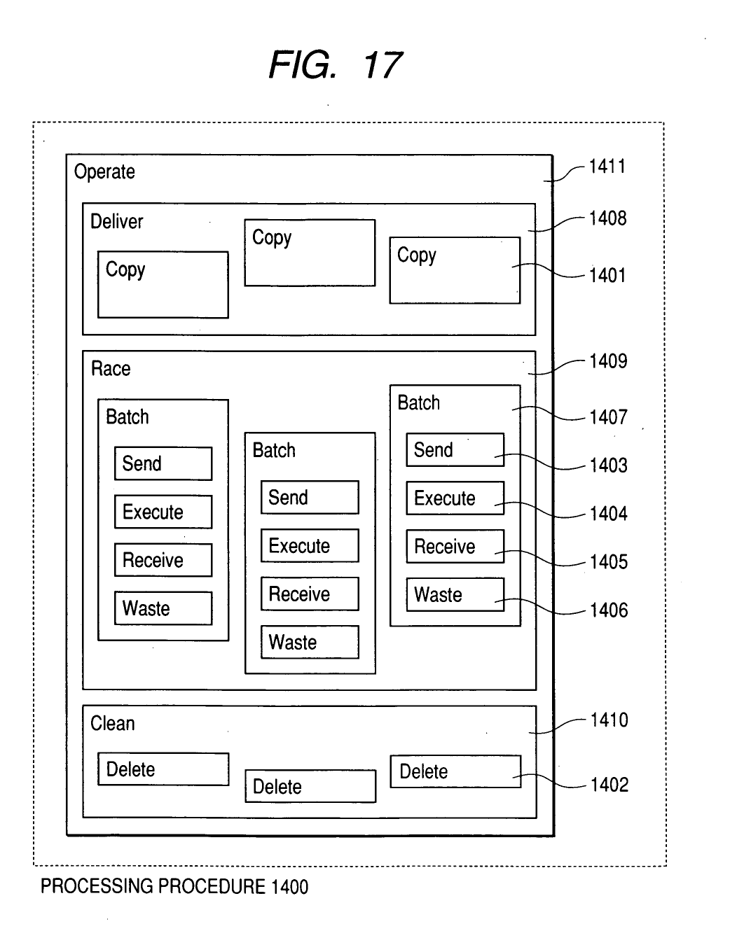

FIG. 17 shows an example of the procedure 1400 that dominates the operation (scheduling) of the scheduler 1210. The procedure 1400 is hierarchically divided into several parts. The processes that are conducted in the respective parts are as follows.

(1) Copy part 1401

One piece of data at a node is copied to another node.

(2) Delete part 1402

One piece of data at a node is deleted.

(3) Send part 1403

Data at a master node is copied to a slave node.

(4) Execute part 1404

A slave node is allowed to execute a task.

(5) Receive part 1405

A data at a slave node is copied to a master node.

(6) Waste part 1406

Data at a slave node is deleted.

(7) Batch part 1407

One slave node is allowed to conduct a dispersion process.

(8) Deliver part 1408

Data at a master node is copied to all of slave nodes.

(9) Race part 1409

All of slave nodes are allowed to conduct a dispersion process.

(10) Clean part 1410

Data at all of the nodes is deleted.

(11) Operate part 1411

The cluster computer 100 is operated.

In the present specification, the computer 110 that is managed by the scheduler 1210 is called “node”. The scheduler 1210 uses a node list 1510 that will be described later while operating by the master computer 110a, to thereby manage both of the master node and the slave node in an integrated fashion.

The scheduler 1210 uses a data arrangement table 1212 and a node attribute table 1213 in scheduling.

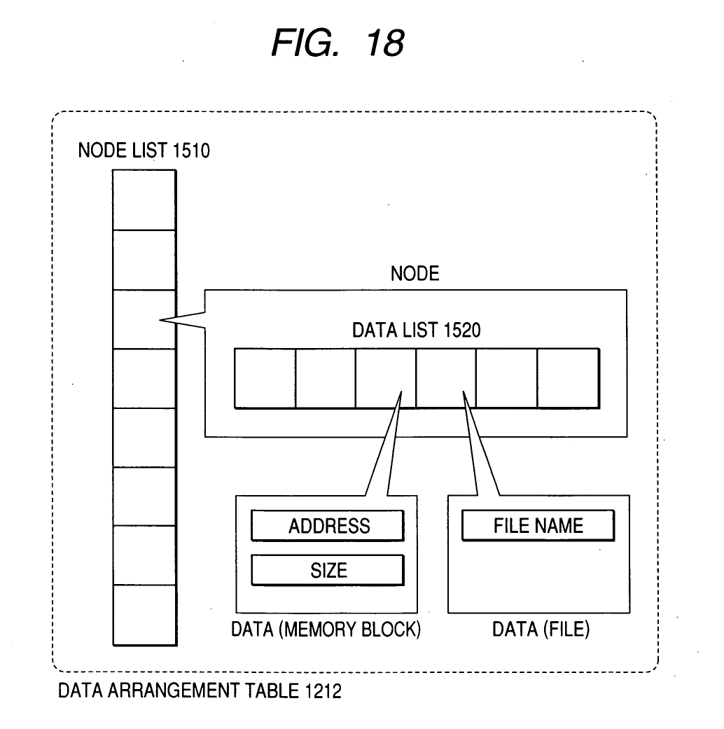

The data arrangement table 1212 has a function of grasping and managing data that is held by the respective computers 110, for example, with a data structure shown in FIG. 18. A node list 1510 is a list of the computers included in the cluster computer 100, and holds nodes that are elements corresponding to the respective computers 110. The respective nodes hold a data list 1520. The data list 1520 is a list of data (memory block file) which is held by the computer 110.

The data arrangement table 1212 is automatically updated every time the scheduler 1210 allows data to be copied or erased. For that reason, the scheduler 1210 refers to the data arrangement table 1212, thereby making it possible to know the data arrangement status at this time point.

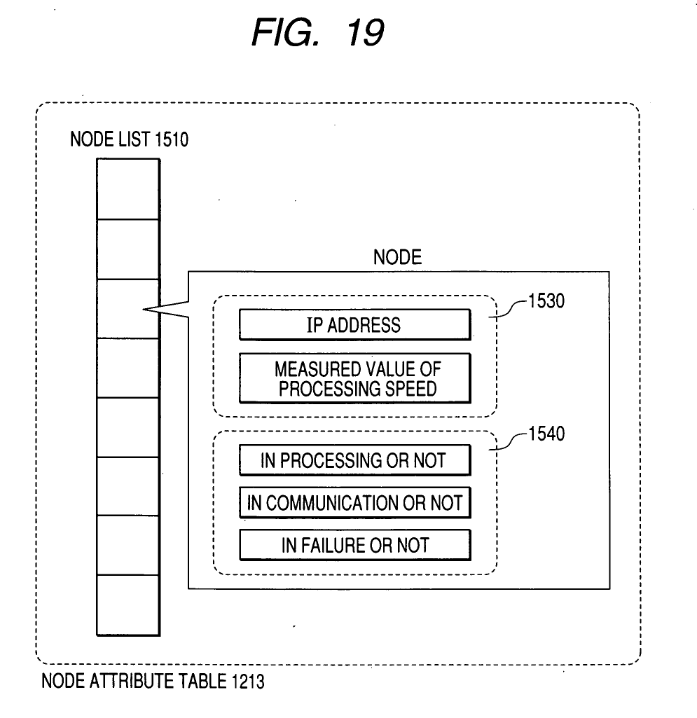

The node attribute table 1213 has a function of grasping and managing an attribute 1530 related to the respective computers 110 (nodes) and a status 1540, for example, with the data structure shown in FIG. 19. The attribute 1530 of the node includes the following matters.

(1) IP address

(2) Measured value of a processing speed

Also, the status 1540 of the node includes the following matters.

(3) Whether it is in processing, or not (whether the event handler is executed, or not).

(4) Whether it is in communication, or not (whether the network is used, or not).

(5) Whether it is in failure, or not.

The status 1540 of the node that is held in the node attribute table 1213 is also updated with the operation (scheduling) of the scheduler 1210. For that reason, the scheduler 1210 refers to the node attribute table 1213, thereby making it possible to know the status 1540 of the node at that time point.

Subsequently, a description will be given of how the data arrangement table 1212 and the node attribute table 1213 being used when the scheduler 1210 conducts scheduling. In this example, the procedure 1400 will be described with reference to the following six cases.

(1) Data delivery at once (execution of deliver part 1408)

(2) Data erasing at once (execution of clean part 1410)

(3) Dispersion process (execution of race part 1409)

(4) Acquisition of a processing completion ratio

(5) Interrupt of processing

(6) failures of slave computers 110b to 110i

(1. Data Distribution at Once)

In the deliver part 1408, data included in the operation object data list 1211 is copied to all of the slave nodes from the master node. In order to realize this operation, the scheduler 1210 refers to the data arrangement table 1212, and selects one each from a node that holds the data and a node that does not hold the node. Random number may be used for that selection, or a topology where the computer 110 is connected to the network 120 may be used therefore. For example, in the network 120 having the topology with a tree structure including plural hubs, there is a tendency that the communication volume of transmission paths that connect the hubs becomes much larger than that of other transmission paths. Under the circumstances, when data is going to be copied preferentially with respect to the nodes that are large in the number of routes of the hubs, that is, apart from the transmitting node in phase, since the transmission path that connects the hubs passes data only once, the performance of the system is improved.

The node whose present status is processing or communicating cannot conduct the transmission and reception of data. Therefore, the scheduler 1210 refers to the node attribute table 1213 and prevents the use of those nodes. When the data transmitting node and the data received node are determined, the scheduler 1210 instructs the transmitting node to transmit data to the receiving node. When the data copying starts, the scheduler 1210 updates the note attribute table 1213, and changes the statuses of the transmitting node and the received node to in-communication. When the data copying has been completed, the scheduler returns those node statuses to original statuses. In this way, the scheduler 1210 repeats the above operation until all of the nodes hold the data..

(2. Date Erasing at Once)

In the clean part 1410, data that is held in the respective nodes is erased. In order to realize that operation, the scheduler 1210 selects the node, refers to the data arrangement table 1212, and acquires a list of data that is held in the node. Thereafter, the scheduler 1210 instructs the node to erase the respective data. The scheduler 1210 conducts the above operation on all of the nodes.

(3. Dispersion Process)

In the race part 1409, the respective slave nodes are allowed to execute partial processes (tasks) which are finely divided processes of the entire process to be naturally conducted is finely divided. In the slave modules 1300b to 1300i of the application 1300, the respective tasks are set as the event handlers in advance. For that reason, the operation of the scheduler 1210 finds out the nodes whose present status is neither processing nor communicating, and instructs the nodes to generate the event. In order to grasp the status of the nodes, the scheduler 1210 refers to the node attribute table 1213. In the case where the scheduler 1210 finds out useable nodes, the scheduler 1210 selects one from the useable nodes. A random number may be used, or in the case where the measured values of the processing speeds of the respective nodes are found, there is applied a method in which a node low in the processing speed is not assigned to the almost last tasks. This is because when the node low in the processing speed is allowed to execute the final task, it makes the overall system wait, thereby making the performance low. When the node starts to execute the event handler, the scheduler 1210 updates the node attribute table 1213 and changes the node status to in-processing. Also, when the node has completely executed the event handler, the scheduler 1210 returns the node status to an original status. The scheduler 1210 repeats the above operation until all of the tasks that have been divided as described above are executed.

(4. Acquisition of Processing Completion Ratio)

In the acquisition of the processing completion ratio, the completion ratios are found with respect to the respective tasks, and an average value of those completion ratios is calculated. In the acquisition of the processing completion ratios, the completion ratios are found in the respective tasks, and an average value of those completion ratios is calculated. The scheduler 1210 refers to the node attribute table 1213, thereby making it possible to know the node that is now executing the task. In the slave modules 1300b to 1300i of the application 1300, the scheduler 1210 prepares the event handler that obtains the completion ratio of the task, and can set the event handler in advance. For that reason, the scheduler 1210 that has known the node that executes the task instructs that node to generate the event, and can know the completion ratio of the task. In this way, the scheduler 1210 conducts the same operation with respect to all of the tasks, finally obtains the average, and returns the obtained average to the interrupt request means 1320 of the application 1300.

(5. Interrupt of Processing)

In the interrupt of processing, all of the tasks that are in execution are interrupted, and the distributed temporal data must be erased. In the interrupt of the task, the scheduler 1210 refers to the node attribute table 1213 and can know the node that is now executing the task. In the slave modules 1300b to 1300i of the application 1300, the event handler that interrupts the task can be prepared. In other words, the scheduler 1210 instructs all of the nodes that are executing the task to generate the event.

Also, in order to erase all of the temporal data, the scheduler 1210 acquires a list of the temporal data with reference to the table arrangement table 1212, and thereafter instructs the node that holds the data to erase those data.

(6. Failure of Slave Computers 110b to 110i)

In the case where any one of the slave computers 110b to 110i fails, the scheduler 1210 updates the node attribute table 1213, and changes the status of the failed node to in-failure. As a result, the scheduler 1210 prevents the use of the failed node. In addition, the scheduler 1210 allows the tasks that have been executed by the failed node to be again executed by another unfailed slave node. The re-execution of the task can be conducted by again executing the batch part 1407 including the task.

The cluster computer middleware 1200 exports a routine for starting the operation of the scheduler 1210 with respect to the application 1300. For that reason, the application 1300 can start the operation of the scheduler 1210 at an arbitrary timing. However, once the scheduler 1210 starts to operate, since the control shifts to the scheduler 1210, the control does not return to the application 1300 until the operation is completed.

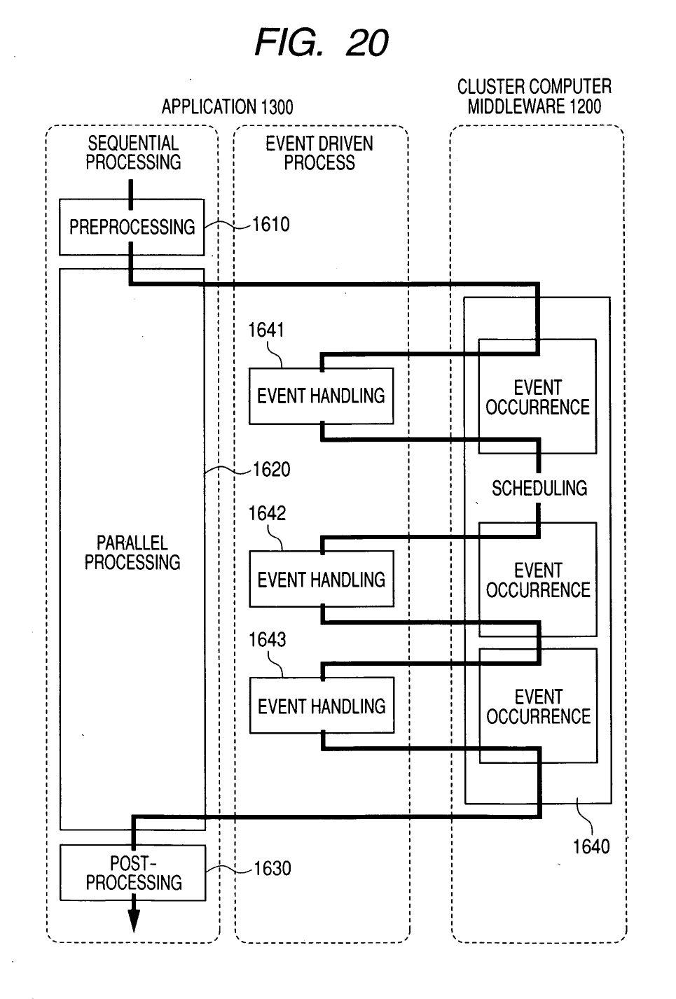

FIG. 20 shows an appearance in which control moves with time between the cluster computer middleware 1200 and the application 1300. In this example, the terms of “sequential” and “event driven are used, and the definitions of those terms will be described later after the description is first given. In an initial status, the application 1300 has control. The application 1300 executes a preprocessing 1610 in “sequential”, and thereafter starts a parallel processing 1620 in “sequential”, likewise. As a result, the operation of the scheduler 1210 (scheduling 1640) is started. The actual process of the parallel processing 1620 is a process that executes event handlings 1641, 1642, and 1643 corresponding to an event when that event is generated while waiting for the completion of the operation of the scheduler 1210. In other words, the event handlings 1641, 1642, and 1643 are executed in “event driven” with an advance of the scheduling 1640. When the final procedure is completed and the operation of the scheduler 1210 is finished, control is again returned to the application 1300, and a post-processing 1630 subsequent to the parallel processing 1620 is executed in “sequential”.

In this case, “sequential” means that processing is executed at a timing written in program, or executed in order predicted from the source code. On the contrary, “event driven” means that processing is not executed at a timing written in the program, or executed in order that cannot be predicted from the source code. Those distinctions are readily understood by viewing the source code of the application 1300. The source code will be described later.

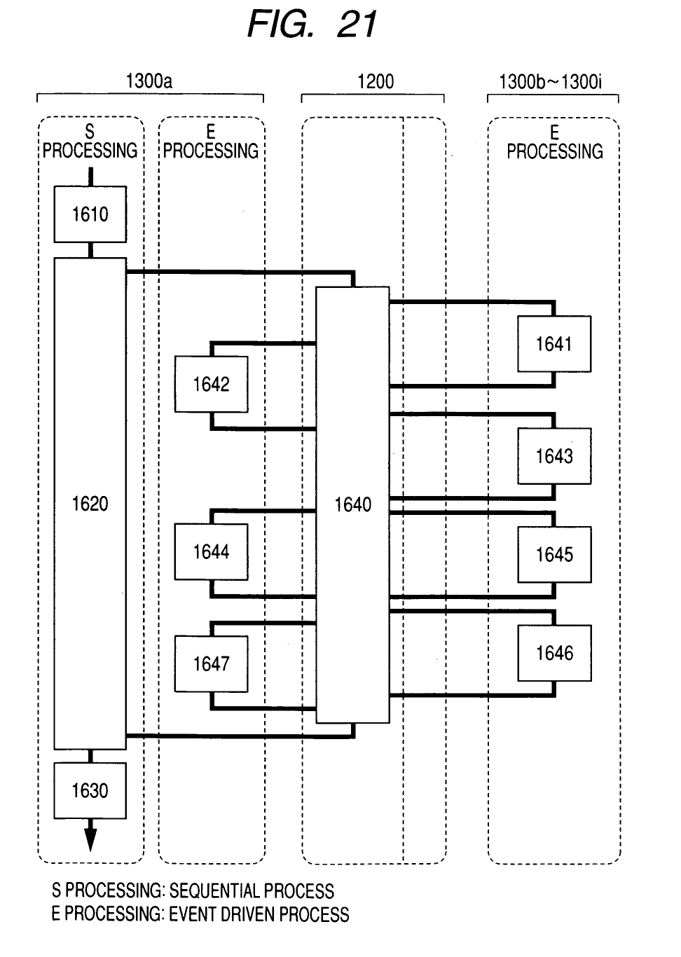

Since the actual cluster computer middleware 1200 and the application 1300 are divided into the master modules and the slave modules, respectively, an appearance in which the control moves is actually more complicated than that shown in FIG. 20, and is actually like one shown in FIG. 21. It should be noted that in the cluster computer 100 that is made up of plural computers 110, there is the possibility that some of the event handlings 1641 to 1647 are finished completely simultaneously. As a result, it is necessary to provide unit for serializing the completion notifications that have been received at the same time in time series. For example, this can be realized by using a queue or a FIFO buffer.

Also, the event handlings 1641 to 1647 are not always executed in the order of the divided tasks. Therefore, in order to transmit the contents of the tasks to be executed to the respective slave computers 110b to 110i, numbers for identifying the tasks are given to the event handler as arguments.

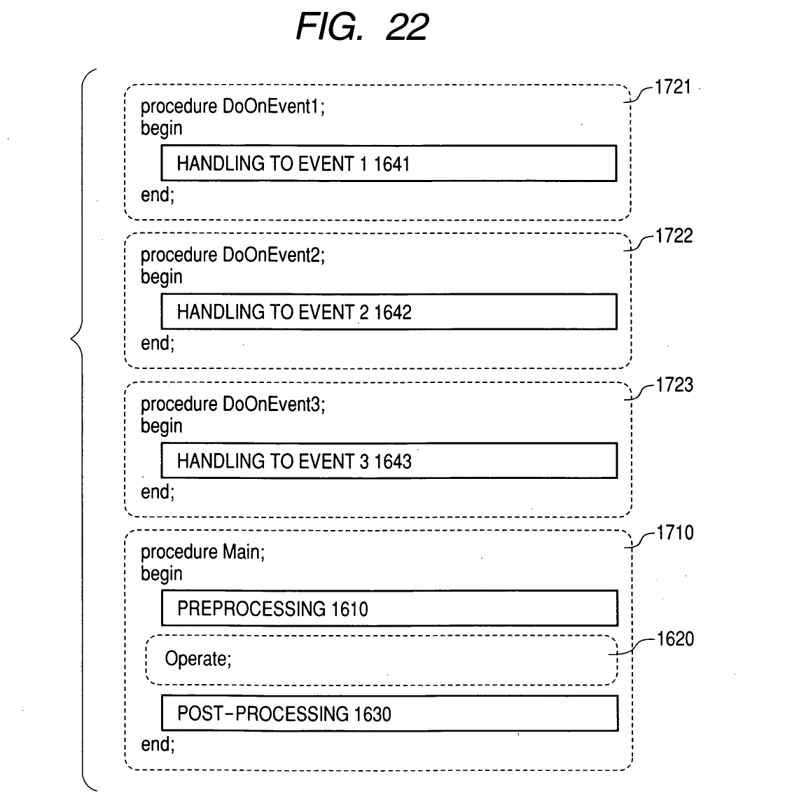

FIG. 22 shows the source code of the maser module 1300a of the application 1300. Since the preprocessing 1610, the parallel processing 1620, and the post-processing 1630 are executed sequentially, those processing is described on the source code sequentially to a main routine 1710. On the contrary, since the event handlings 1641, 1642, and 1643 execute the event occurrence as a trigger, those processing is not always executed in the order of event handlers 1721, 1722, and 1723 that are described on the source code. The order of the event occurrence is determined as the result that the scheduler 1210 actually operates. This is dynamically changed due to various factors such as a procedure that dominates the operation of the scheduler 1210, the number of computers 110 and the connecting method of the computers 110, a variation in the performance of the computers 110, the presence or absence of an interrupt processing request, or the fortuity of a random number used in the interior.

As described above, the parallel processing in the cluster computer middleware 1200 according to this embodiment is realized as the combination of the scheduling that blocks (suspends) the main routine 1710 and operates and the plural event handlers 1721, 1722, and 1723 that operate asynchronously with respect to the main routine 1710.

This means that “the application 1300 must install the parallel processing by only processing (event handling) that is executed by event driven”. This imposes a type of constraint on the application 1300. However, this limit is complied with, thereby concealing the actual configuration of the cluster computer 100 from the application 1300. As a result, a developer of the application 1300 can enjoy the following effect.

(1) Since it is unnecessary to install the scheme that manages the respective computers 110 or conducts scheduling, it is easy to implant or develop the application 1300.

(2) The application 1300 does not depend on the number of computers 110 or the type of network 120. For that reason, it is possible to distribute the application 1300 to unspecific number of users for use.

(3) Since the parallel processing to be conducted by the application 1300 can be described as the assembly of the event handlers of the same type, it is easy to read the source code. Also, when the processing contents of the event handler is changed, various parallel processing can be described. In other words, both of the readability of the source code and the degree of freedom of procedure can be satisfied.

(4) Since the application 1300 does not depend on the procedure of the scheduler 1210, the future upward compatibility is ensured. Even if the scheduler 1210 is improved, it is unnecessary to correct the application 1300.

(5) The scheduler 1210 can know the computer 110 that is now conducting the event handling and data that is held by the respective computers 110. For that reason, the scheduler 1210 can automatically assign appropriate instructions to the individual computers 110 in response to a request of the interrupt processing such as the acquisition of the processing completion ratio or the interrupt of processing. For that reason, it is unnecessary to install the above scheme in the application 1300.

(6) When there is provided a cluster simulator having the scheduler 1210 of the same procedure as that of the cluster computer 100, the scheduler 1219 can operate the application 1300 even if the cluster computer 100 is not actually provided. For that reason, it is possible to execute the team development or advanced development of the application 1300, and the cross debug of the maser module 1300a and the slave modules 1300b to 1300i.

As described above, according to the fifth embodiment of the present invention, the cluster computer middleware that is made up of the master module and the slave modules includes a scheduler that temporarily blocks the processing of the application and operates, and unit for executing the event handler that is set by the application in advance upon receiving an instruction from the scheduler. As a result, there can be provided an environment that can develop the parallel application without needing the considerable costs and efforts and advanced knowledge and technology. Also, there can be provided an environment that can develop the parallel application having high extensibility and upward compatibility.

1. Cluster computer middleware which is operable on a cluster computer comprised of a plurality of computers connected to each other via a communication network and provides an application with a function of cooperatively operating said plurality of computers, said cluster computer middleware comprising:
a function of receiving an instruction from said application operating on one or more of said plurality of computers;
a function of supplying a notification to said application;
a function of publishing sessions constituting a specified topological structure representing a process to be performed by said computer; and
a function of supplying said application with said single notification indicating initiation of each of said sessions and said single notification indicating termination of each of said sessions.

2. The cluster computer middleware according to claim 1 comprising:
a function of holding said current session; and
a function of using, as a trigger, a notification asynchronously sent from said computer to update said session.

3. The cluster computer middleware according to claim 1,
wherein an anteroposterior relation or an inclusion relation is specified for said plurality of sessions.

4. The cluster computer middleware according to claim 1 comprising:
a function of supplying said application with information for specifying said session causing an error which may occur in the middle of a process.

5. The cluster computer middleware according to claim 1 including:
said session to copy data from a master node to a slave node;
said session to delete data from a slave node;
said session to copy data from a master node to all slave nodes at a time; and
said session to delete data from all nodes at a time.

6. A cluster computer simulator to supply an application with a function of simulating operations of a cluster computer according to claim 1, comprising:
a function of receiving an instruction from said application operating on one computer;
a function of supplying a notification to said application;
a function of publishing sessions constituting a specified topological structure representing a process to be performed by said computer; and
a function of supplying said application with said single notification indicating initiation of each of said sessions and said single notification indicating termination of each of said sessions.

7. The cluster computer simulator according to claim 6 comprising:
a function of holding said current session; and
a function of using, as a trigger, a notification asynchronously sent from a simulator simulating operations of said computer to update said session.

8. The cluster computer simulator according to claim 6,
wherein an anteroposterior relation or an inclusion relation is specified for said plurality of sessions.

9. The cluster computer simulator according to claim 6 comprising:
a function of supplying said application with information for specifying said session causing an error which may occur in the middle of a process.

10. The cluster computer simulator according to claim 6 including:
said session to copy data from a master node to a slave node;
said session to delete data from a slave node;
said session to copy data from a master node to all slave nodes at a time; and
said session to delete data from all nodes at a time.

11. An application that is operable by one or plurality of computers in a cluster computer which is made up of a plurality of computers connected on a communication network,
wherein the application obtains a function of cooperating the plurality of computers by a cluster computer middleware that operates on the cluster computer,
wherein the application includes:
a function of sending an instruction to the cluster computer middleware;
a function of receiving the notification from the cluster computer middleware; and
a function of receiving the notification indicative of a start and the notification indicative of an end one by one with respect to the respective sessions where a process to be conducted by the computer is divided into given phase configurations from the cluster computer middleware;
a function of holding a routine that performs a process for said notification issued in response to initiation of said session;
a function of supplying said cluster computer middleware with information needed to perform said routine; and
a function of issuing an instruction to start said session.

12. An application that is operable by a computer which stores and holds the configuration of a cluster computer made up of a plurality of computers connected on a communication network,
wherein the application receives a function of simulating the operation of the cluster computer from a cluster computer simulator,
wherein the application includes:
a function of sending an instruction to the cluster computer simulator;
a function of receiving the notification from the cluster computer simulator;
a function of receiving the notification indicative of a start and the notification indicative of an end one by one with respect to the respective sessions where a process to be conducted by the computer is divided into given phase configurations;
a function of holding a routine that performs a process for said notification issued in response to initiation of said session;
a function of supplying said cluster computer simulator with information needed to perform said routine; and
a function of issuing an instruction to start said session.

13. The application according to claim 11 comprising:
a function of issuing said instruction to start said session and then receiving a notification indicating termination of said session corresponding to said instruction.

14. A session display method of visually displaying, on a display, said session according to claim 3 and its topological structure, said method comprising the steps of:
representing each of said sessions in rectangles;
horizontally disposing rectangles representing a plurality of sessions having said anteroposterior relation; and
nesting rectangles representing a plurality of sessions having said inclusion relation.

15. An application development supporting method used to develop the application according to claim 1 including the steps of:
developing a simulating application operated by the cluster computer simulator according to claim 6 for holding said session having the same topological structure as that of said cluster computer middleware; and
porting said simulating application to the cluster computer middleware according to claim 1.

16. A cluster computer middleware that is operable on a cluster computer that includes one master computer, at least one slave computers, and a network that connects the master computer and the slave computer to each other, the cluster computer middleware comprising:
a master module that can link with a master application which operates by the master computer; and
a slave module that can link with a slave application that operates by the slave computer,
wherein the master module includes a scheduler that produces a parallel procedure to be executed by the cluster computer,
wherein the scheduler suspends the processing of the master application, and restarts the processing of the master application after completion of the operation,
wherein each of the master module and the slave module includes unit for mutually communicating with one of another master module and the slave module on the basis of an instruction received from the scheduler; and
unit for executing the event handler that is set by one of the master application and the slave application in advance on the basis of the instruction received from the scheduler.

17. The cluster computer middleware according to claim 16, wherein the routine having a function of operating according to a call from a processing system that consecutively executes the routine, starting the operation of the scheduler, and waiting for the completion of the scheduler is published in the processing system.

18. The cluster computer middleware according to claim 16,
wherein one of the master module and the slave module includes data copying unit for copying data, and data erasing unit for erasing data, and wherein the scheduler includes unit for operating the data copying means and the data erasing means.

19. The cluster computer middleware according to claim 18,
wherein each of the master module and the slave module includes unit for transmitting a notification that notifies the scheduler of the completion of at least one of the event handler execution, the data copying, and the data erasing to the scheduler, and
wherein the scheduler includes unit for serializing the notification that is transmitted from the master module and the slave module in time series.

20. The cluster computer middleware according to claim 18,
wherein the event handler includes unit for adding the data to be copied or erased to the list, or unit for deleting the data to be copied or erased from the list, and
wherein the scheduler has unit for operating the data copying means and the data erasing means on the basis of the list.

21. The cluster computer middleware according to claim 18,
wherein the master module includes unit for receiving a processing interrupt request from the master application, and
wherein the scheduler includes unit for managing the arrangement of the data to be copied or erased, and unit for transmitting an instruction for erasing the intermediate data to the data erasing means on the basis of the arrangement of data when receiving the processing interrupt request.

22. The cluster computer middleware according to claim 16, wherein the scheduler includes unit for managing the statuses of the master computer and the slave computer, and assigning plural times of executions of the event handler to the master module or the slave module on the basis of the statuses of the master computer and the slave computer.

23. The cluster computer middleware according to claim 22,
wherein the scheduler includes unit for grasping the processing speeds of the master computer and the slave computer, and unit for assigning the executions of the event handler to the higher processing speed of the master computer and the slave computer preferentially.

24. The cluster computer middleware according to claim 22, wherein the scheduler delivers information that uniquely identifies the master computer and the slave computer or information that uniquely identifies the respective executions of the event handler to the event hander in execution of the event hander that is assigned to the master module and the slave module.

25. The cluster computer middleware according to claim 16, wherein the scheduler includes unit for detecting the failure of the slave computer, and unit for resending a replication of the instruction that has been sent to the failed slave module to another un-failed slave module after the detecting means detects the failure.

26. The cluster computer middleware according to claim 18, wherein the scheduler includes unit for copying data to another slave module with respect to the data copying means of at least one slave module.

27. The cluster computer middleware according to claim 26,
wherein a topology of the network is of a tree structure having a plurality of hubs, and
wherein the scheduler includes unit for grasping the topology of the network, and unit for determining whether the copying master module or the copying slave module and another copied slave module are connected to the different hub, or not, and selecting another copied slave module on the basis of the result of determination.

28. A computer-readable recording medium which records the cluster computer middleware according to claim 1.

29. A computer-readable recording medium which records the cluster computer simulator according to claim 6.

30. A computer-readable recording medium which records the application according to claim 11.
